(19) United States
(12) Patent Application Publication
(10) Pub. No.: US 2009/0283101 A1
(43) Pub. Date: Nov. 19, 2009

(54) DEVICE FOR PROTECTING A NIPPLE OF A MOTHER DURING NURSING

(76) Inventor: Erin K. Mans, North Branch, MN (US)

Correspondence Address: Erin K Mans, 7435 381st ST, North Branch, MN, 55056, US

(21) Appl. No.: 12/437,039

(22) Filed: May 7, 2009

Related U.S. Application Data
(60) Provisional application No. 61/053,346, filed on May 15, 2008.

(51) Int. Cl. A61J 13/00

(52) U.S. Cl. 128/890

(57) ABSTRACT

A device for protecting a nipple of a mother during nursing includes a collar generally configured to removably join to a portion of the mother's breast surrounding the nipple. The collar includes an annular opening and a cut out for enabling additional skin contact between the mother and the feeding baby. The collar is comprised of a pliable material. Means removably joins the collar to the mother's breast. A funnel extends from the annular opening for surrounding the nipple. The funnel includes an opening at a distal end for enabling the mother's milk to flow out to a feeding baby. The collar is comprised of a pliable material and a wall of the funnel is generally thicker than a wall of the collar for mitigating effects of the nipple being bitten by the feeding baby.

### CROSS-REFERENCE TO RELATED APPLICATIONS

The present Utility patent application claims priority benefit of the U.S. provisional application for patent serial number 61053346 filed on May 15, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to breastfeeding equipment. More particularly, the invention relates to a nipple guard designed to ease the pain of nursing a biting or teething baby.

### BACKGROUND OF THE INVENTION

The present invention relates to a silicone nipple guard designed to ease the pain of nursing a biting or teething baby. When a baby is teething, he may chew on a nursing mother's nipple to soothe his discomfort. This can be very painful to the mother, and in some cases the mother's nipple may be injured by the biting or chewing. If the mother stops nursing when the baby begins to teethe, the advantages of nursing (e.g., the nutritional benefits of breast milk and the bonding between mother and child) are cut short as some babies may begin teething at only a few months of age. Furthermore, many mothers with teething or biting babies want the benefits of feeding their child breast milk yet do not want to express their breast milk to feed the baby with a bottle. It is therefore an objective of the present invention to provide means that enable a mother to nurse a biting or teething baby while reducing the pain caused to the mother.

In view of the foregoing, there is a need for improved techniques for providing a device that protects the nipple of a mother from being bitten by a nursing baby.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, 1C, 1D, and 1E illustrate an exemplary nipple guard with an open end, in accordance with an embodiment of the present invention. FIG. 1A is a side perspective view. FIG. 1B is a diagrammatic top view. FIG. 1C is a diagrammatic bottom view. FIG. 1D is a diagrammatic side view, and FIG. 1E is a cross sectional view;

FIG. 2 is a side perspective view of an exemplary nipple guard with an enclosed end and a lip, in accordance with an embodiment of the present invention; and

FIG. 3 is a side perspective view of an exemplary nipple guard with an enclosed end, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of techniques for a device for protecting a nipple of a mother during nursing are described.

In one embodiment a device for protecting a nipple of a mother during nursing is presented. The device includes means for removably joining to a portion of the mother's breast surrounding the nipple and means joined to the joining means for surrounding the nipple and for enabling the mother's milk to flow out to a feeding baby. Another embodiment further includes means for mitigating effects of the nipple being bitten by the feeding baby. Yet another embodiment further includes means for enabling additional skin contact between the mother and the feeding baby. Still another embodiment further includes means for engaging the feeding baby's teeth to mitigate the feeding baby's teeth from coming into contact with the nipple. Another embodiment further includes means for generally enclosing the nipple and enabling the mother's milk to exit to the feeding baby. Yet another embodiment further includes means for removably joining the joining means to the mother's breast. Still another embodiment further includes means for enabling the mother's breast skin to breath.

In another embodiment a device for protecting a nipple of a mother during nursing is presented. The device includes a collar generally configured to removably join to a portion of the mother's breast surrounding the nipple. The collar includes an annular opening. A funnel extends from the annular opening for surrounding the nipple. The funnel includes an opening at a distal end for enabling the mother's milk to flow out to a feeding baby. In another embodiment a wall of the funnel is generally thicker than a wall of the collar for mitigating effects of the nipple being bitten by the baby. In yet another embodiment the collar further includes a cut out for enabling additional skin contact between the mother and the feeding baby. In still another embodiment the funnel further includes a lip surrounding the distal end for engaging the feeding baby's teeth to mitigate the feeding baby's teeth from coming into contact with the nipple. In other embodiments the funnel further includes a enclosed end for generally enclosing the nipple, the enclosed end comprising at least one opening at a distal end of sufficient size to allow the mother's milk to exit to the feeding baby, the at least one opening includes a slit and the enclosed end generally includes a dome shape. Yet another embodiment further includes means for removably joining the collar to the mother's breast. In another embodiment the collar and the funnel are comprised of a pliable material. In still another embodiment at least the collar further includes perforations for enabling the mother's breast skin to breath.

In another embodiment a device for protecting a nipple of a mother during nursing is presented. The device includes a collar generally configured to removably join to a portion of the mother's breast surrounding the nipple. The collar includes an annular opening and a cut out for enabling additional skin contact between the mother and the feeding baby. The collar is comprised of a pliable material. Means removably joins the collar to the mother's breast. A funnel extends from the annular opening for surrounding the nipple. The funnel includes an opening at a distal end for enabling the mother's milk to flow out to a feeding baby. The collar is comprised of a pliable material and a wall of the funnel is generally thicker than a wall of the collar for mitigating effects of the nipple being bitten by the feeding baby. In another embodiment the funnel further includes a lip surrounding the distal end for engaging the feeding baby's teeth to mitigate the feeding baby's teeth from coming into contact with the nipple. In still another embodiment the funnel further includes a enclosed end extending from the distal end for generally enclosing the nipple, the enclosed end comprising a generally dome shape and at least one opening at a distal end of the dome shape of sufficient size to enable the mother's milk to exit to the feeding baby.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a silicone open-ended form that fits over the nipple and part of the breast. In preferred embodiments, the silicone on the nipple is thicker to ease the pain of nursing a teething baby. Preferred embodiments also enable a mother to continue to nurse while healing from an injury to the nipple area.

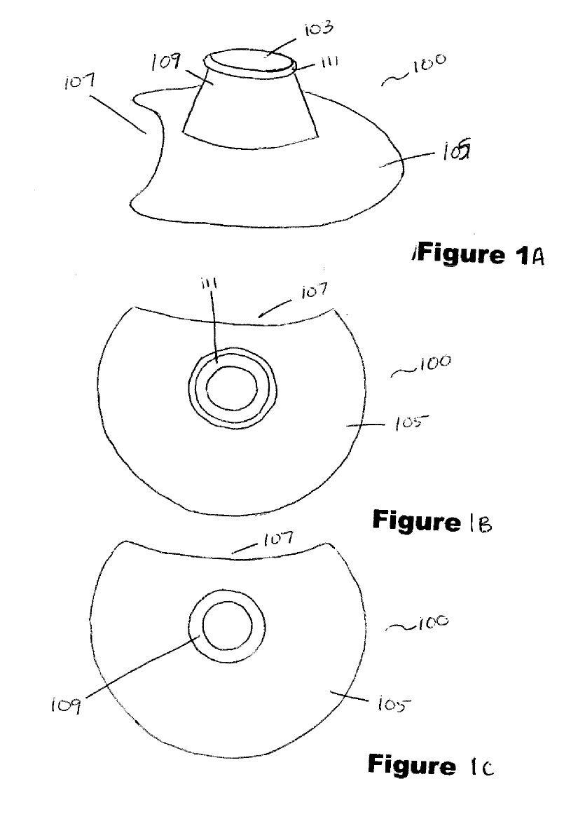

FIGS. 1A, 1B, 1C, 1D, and 1E illustrate an exemplary nipple guard 100 with an open end 103, in accordance with an embodiment of the present invention. FIG. 1A is a side perspective view. FIG. 1B is a diagrammatic top view. FIG. 1C is a diagrammatic bottom view. FIG. 1D is a diagrammatic side view, and FIG. 1E is a cross sectional view. In the present embodiment, nipple guard 100 is a silicone mold formed to fit over a woman's nipple and a portion of the breast. Nipple guard 100 has a collar 105, which sits on the breast during use. Collar 105 comprises a cut out 107 that allows more skin contact between the mother and the baby; however, alternate embodiments may not comprise a cut out. In the present embodiment, an open-ended funnel 109 extends from collar 105 and covers the nipple during use. Open end 103 of funnel 109 enables milk to flow through to the mouth of the baby. In the present embodiment, open end 103 comprises a lip 111; however, alternate embodiments may be implemented without a lip.

Referring to FIG. 1E, the silicone at collar 105, which sits on the breast, is thin to allow enough stimulation to the breast to produce milk, and the silicone at funnel 109 is thicker to cushion the mother's nipple if the baby bites to ease the pain. Furthermore, if the baby bites and pulls, the baby's teeth catch lip 111 rather than contacting the exposed nipple. In alternate embodiments, nipple guards may have lips with various different shapes to prevent teeth slippage. For example, without limitation, the lips in alternate embodiments may have cross sections with shapes other than curves such as, but not limited to circular cross sections, rectangular cross sections, etc.

In typical use of the present embodiment, nipple guard 100 enables a mother to nurse her teething baby without the discomfort of being bitten. If the baby bites and pulls, the point of contact between the baby's teeth and the mother's nipple moves toward open end 103 of funnel 109 where the silicone is thicker to help ease the pain of being bitten. In addition, as the baby's teeth move toward the end of funnel 109, lip 111 catches the baby's teeth to generally prevent the teeth from coming into contact with the exposed nipple. If the baby bites and pulls strongly, the worst thing that will happen is that nipple guard 100 may separate from the breast. Nipple guard 100 also enables a mother to continue nursing while healing from an injury to the nipple area. While using nipple guard 100, the mother may also be able to use medications on the affected area while continuing to nurse.

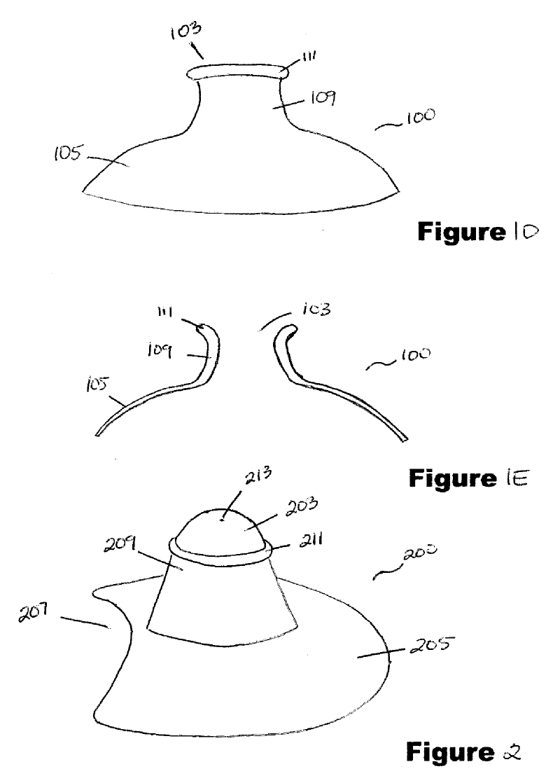

FIG. 2 is a side perspective view of an exemplary nipple guard 200 with an enclosed end 203 and a lip 211, in accordance with an embodiment of the present invention. In the present embodiment, nipple guard 200 comprises a collar 205, a cut out 207 and a funnel 209, similar to nipple guard 100 shown by way of example in FIGS. 1A through 1E. However, end 203 of funnel 209 is enclosed rather than open to cover the entire nipple. Enclosed end 203 comprises holes or slits 213 to enable the breast milk to exit funnel 209 when a baby is nursing. The silicone at funnel 209 is thicker than the silicone at collar 205 to ease the pain of a biting baby. Lip 211 generally prevents the baby's teeth from reaching enclosed end 203 of funnel 209. In an alternate embodiment a nipple guard with an enclosed end may be implemented without a cut out.

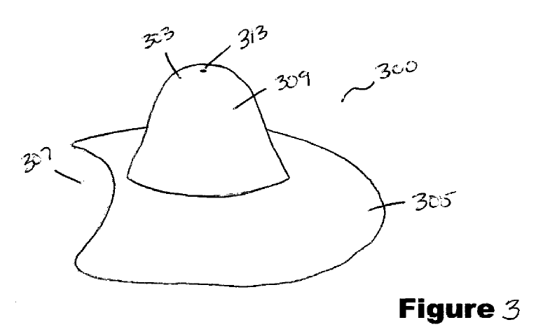

FIG. 3 is a side perspective view of an exemplary nipple guard 300 with an enclosed end 303, in accordance with an embodiment of the present invention. In the present embodiment, nipple guard 300 comprises a collar 305, a cut out 307 and a funnel 309. End 303 of nipple guard 300 is enclosed to cover the entire nipple similarly to nipple guard 200 shown by way of example in FIG. 2. However, end 303 of funnel 309 does not comprise a lip. Enclosed end 303 comprises holes or slits 313 to enable the breast milk to exit funnel 309 when a baby is nursing. The silicone at funnel 309 is thicker than the silicone at collar 305 to ease the pain of a biting baby. In an alternate embodiment a nipple guard with an enclosed end and no lip may be implemented without a cut out.

In alternate embodiments, nipple guards may be implemented in different sizes, shapes, thicknesses, and colors. Other alternate embodiments may comprise various additional features such as, but not limited to, adhesive areas or straps to secure the guard to the breast, caps to prevent leakage when the baby is not nursing, perforations to enable the skin to breath, etc.

Having fully described at least one embodiment of the present invention, other equivalent or alternative methods of providing a nipple guard according to the present invention will be apparent to those skilled in the art. The invention has been described above by way of illustration, and the specific embodiments disclosed are not intended to limit the invention to the particular forms disclosed. For example, the particular implementation of the nipple guard may vary depending upon the particular type of material used. The nipple guards described in the foregoing were directed to silicone implementations; however, similar techniques are to make nipple guards out of various different materials such as, but not limited to, various pliable plastics, rubber, etc. Non-silicone implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A device for protecting a nipple of a mother during nursing, the device comprising:
means for removably joining to a portion of the mother's breast surrounding the nipple; and
means joined to said joining means for surrounding the nipple and for enabling the mother's milk to flow out to a feeding baby.

2. The device as recited in claim 1, further comprising means for mitigating effects of the nipple being bitten by the feeding baby.

3. The device as recited in claim 1, further comprising means for enabling additional skin contact between the mother and the feeding baby.

4. The device as recited in claim 1, further comprising means for engaging the feeding baby's teeth to mitigate the feeding baby's teeth from coming into contact with the nipple.

5. The device as recited in claim 1, further comprising means for generally enclosing the nipple and enabling the mother's milk to exit to the feeding baby.

6. The device as recited in claim 1, further comprising means for removably joining said joining means to the mother's breast.

7. The device as recited in claim 1, further comprising means for enabling the mother's breast skin to breath.

8. A device for protecting a nipple of a mother during nursing, the device comprising:
a collar generally configured to removably join to a portion of the mother's breast surrounding the nipple, said collar comprising an annular opening; and
a funnel extending from said annular opening for surrounding the nipple, said funnel comprising an opening at a distal end for enabling the mother's milk to flow out to a feeding baby.

9. The device as recited in claim 8, wherein a wall of said funnel is generally thicker than a wall of said collar for mitigating effects of the nipple being bitten by the baby.

10. The device as recited in claim 8, wherein said collar further comprises a cut out for enabling additional skin contact between the mother and the feeding baby.

11. The device as recited in claim 8, wherein said funnel further comprises a lip surrounding said distal end for engaging the feeding baby's teeth to mitigate the feeding baby's teeth from coming into contact with the nipple.

12. The device as recited in claim 8, wherein said funnel further comprises a enclosed end for generally enclosing the nipple, said enclosed end comprising at least one opening at a distal end of sufficient size to allow the mother's milk to exit to the feeding baby.

13. The device as recited in claim 12, wherein said at least one opening comprises a slit.

14. The device as recited in claim 12, wherein said enclosed end generally comprises a dome shape.

15. The device as recited in claim 8, further comprising means for removably joining said collar to the mother's breast.

16. The device as recited in claim 8, wherein said collar and said funnel are comprised of a pliable material.

17. The device as recited in claim 8, wherein at least said collar further comprises perforations for enabling the mother's breast skin to breath.

18. A device for protecting a nipple of a mother during nursing, the device comprising:
a collar generally configured to removably join to a portion of the mother's breast surrounding the nipple, said collar comprising an annular opening and a cut out for enabling additional skin contact between the mother and the feeding baby, wherein said collar is comprised of a pliable material;
means for removably joining said collar to the mother's breast; and
a funnel extending from said annular opening for surrounding the nipple, said funnel comprising an opening at a distal end for enabling the mother's milk to flow out to a feeding baby, wherein said collar is comprised of a pliable material and a wall of said funnel is generally thicker than a wall of said collar for mitigating effects of the nipple being bitten by the feeding baby.

19. The device as recited in claim 18, wherein said funnel further comprises a lip surrounding said distal end for engaging the feeding baby's teeth to mitigate the feeding baby's teeth from coming into contact with the nipple.

20. The device as recited in claim 18, wherein said funnel further comprises a enclosed end extending from said distal end for generally enclosing the nipple, said enclosed end comprising a generally dome shape and at least one opening at a distal end of said dome shape of sufficient size to enable the mother's milk to exit to the feeding baby.
